(19) United States
(12) Patent Application Publication
(10) Pub. No.: US 2019/0278115 A1
(43) Pub. Date: Sep. 12, 2019

(54) Liquid Crystal Composite, Liquid Crystal Element, and Associated Selectively Dimmable Device

(71) Applicant: NITTO DENKO CORPORATION, Osaka (JP)

(72) Inventors: Sazzadur Rahman Khan, San Diego, CA (US); Sergey Simavoryan, San Diego, CA (US); Peng Wang, San Diego, CA (US); Masanori Otsuka, Hiroshima (JP)

(21) Appl. No.: 16/294,796

(22) Filed: Mar. 6, 2019

Related U.S. Application Data
(60) Provisional application No. 62/639,353, filed on Mar. 6, 2018.

(51) Int. Cl. G02F 1/1334; G02F 1/1333; C09K 19/56

(52) U.S. Cl. CPC G02F 1/1334; G02F 2001/13347; C09K 19/56; G02F 1/133305

(57) ABSTRACT

Described herein are reverse-mode polymer dispersed liquid crystal (PDLC) compositions with a plurality of domains. In addition, selectively dimmable reverse-mode PDLC elements and devices using the aforementioned compositions are also described, which are transparent when no voltage is applied and opaque when a voltage is applied.

### CROSS-REFERENCE TO RELATED APPLICATIONS

This application claims the benefit of U.S. Provisional Application Ser. No. 62/639,353, filed Mar. 6, 2018, which is incorporated by reference herein in its entirety.

### BACKGROUND

### Field

These embodiments relate to compounds or compositions having both liquid and crystalline properties. These embodiments also include elements or devices using the aforementioned compounds or compositions.

### Description of the Related Art

In the field of windows, smart windows are attractive alternatives to conventional mechanical shutters, blinds, or hydraulic methods of shading. Currently, there are three main technologies for smart window applications: suspended particle displays (SPD), polymer dispersed liquid crystals (PDLCs), and metal oxide electrochromics (ECs).

One drawback of conventional PDLCs or conventional mode devices is that the window becomes transparent only when a voltage is applied, thus it becomes opaque when the power is off or the power fails. Windows that fail opaque are not desirable in applications where visibility through the window would enhance safety, for example, when there is loss of power in an emergency situation, such as in vehicle or aircraft crash or in a building fire. For electrochromic windows, the application of a voltage is usually needed to trigger a change in the window characteristics, even though one may not be required to maintain dimming. As a result of the desire to have windows fail transparently, advances have been made to create reverse-mode devices such as reverse-mode PDLCs, or PDLCs that are transparent when the power is off.

### SUMMARY

One way of creating reverse-mode PDLCs is to use using liquid crystal nematic compounds, having either negative dielectric anisotropy or positive dielectric anisotropy, and aligning them such that they are transparent in the off state current (in other words, when the power is off). However, these embodiments can have higher voltage requirements, e.g., above 50 volts. Furthermore, these embodiments can have low resulting haze when activated for the desired purposes, e.g., haze of less than 80%.

The desired properties of good mechanical strength, low driving voltages, and high resulting haze achievements, may be difficult to achieve by adjusting the monomer content in a traditional reverse-mode PDLC. Lowering the monomer content below 5 wt % would generate high haze and low driving voltages, however the mechanical strength and device stability may be poor leading, to device breakdown with increasing voltages. To achieve good mechanical strength and device stability, a monomer content greater that 10 wt % may be required. However, monomer content greater than 10 wt % may lead to increased driving voltages and lower haze due to increased resistance to liquid crystal reorientation.

To meet the demands of good mechanical strength, low driving voltage and high haze, there is a need for new liquid crystal compositions to enable enhanced operation of reverse-mode smart windows. Disclosed herein are liquid crystal compositions, including those utilizing a soft polymer network to achieve low driving voltage (<50 volts) along with high haze (>80%) and good mechanical strength (polymer contents up to 50 wt %). Thus, the embodiments described herein overcome the traditional problems of high driving voltages, low haze and poor mechanical strength.

New polymer-liquid crystal compositions have been successfully synthesized which may provide a solution to the previously unmet need for new reverse-mode dimmable devices. The compositions can be used in reverse-mode heterogeneously mixed polymer dispersed liquid crystal (PDLC) dimmable devices. The compositions can be integral to a window or applied as a coating to provide a dimming capability for privacy purposes among others.

Some embodiments include a liquid crystal composite comprising 1, 2, or 3 liquid crystal composite layers. If two or three layers are present, each composite layer has a concentration of a liquid crystal material and a concentration of a polymer that is independent of the other layers. For example, the first liquid crystal composite layer may have a first concentration of the liquid crystal material and a first concentration of the polymer, the second liquid crystal composite layer may have a second concentration of the liquid crystal material and second concentration of the polymer; and the third liquid crystal composite layer may have a third concentration of the liquid crystal material and a third concentration of the polymer. These concentrations may be independent of each other, meaning that each may be different, although it is also possible that two or more concentrations may be the same or similar. For example, it is possible that the first concentration of the liquid crystal material is similar to, or approximately equal to, the third (or the second) concentration of the liquid crystal material.

In some embodiments, the first liquid crystal composite layer can be composed substantially of a fluid phase. In some embodiments the second liquid crystal composite layer can comprise a plurality of liquid crystal domains disposed within the polymer. In some embodiments, the third liquid crystal composite layer can be comprised substantially of a fluid phase.

In some embodiments, the liquid crystal composite can comprise an ionic compound. In some embodiments, the ionic compound can be a quaternary ammonium salt. In some embodiments the quaternary ammonium salt can be comprised of a quaternary ammonium cation. In some embodiments the quaternary ammonium cation can be a cetyltrimethyl-ammonium, which may also be referred to as a hexadecyltrimethyl-ammonium.

In some embodiments, the liquid crystal composite can comprise a plurality of liquid crystal layers. In some embodiments, a first liquid crystal composite layer can comprise a polymer material; the percentage by weight of the polymer material in the first liquid crystal composite layer may be about 5 wt %. In some embodiments, a second liquid crystal composite layer can comprise a polymer material; the percentage by weight of the second liquid crystal composite layers' polymer material may be about 50 wt %. In some embodiments, a third liquid crystal composite layer can comprise a polymer material; the percentage by weight of the polymer material in the third liquid crystal composite layer may be about 5 wt %. In some embodiments, the first liquid crystal composite layer can comprise a liquid crystal material; the percentage by weight of the liquid crystal material in the first liquid crystal composite layer may be about 95 wt %. In some embodiments, the second liquid crystal composite layer can comprise a liquid crystal material; the percentage by weight of the second liquid crystal composite layers' liquid crystal material may be about 50 wt %. In some embodiments, the third liquid crystal composite layer can comprise a liquid crystal material; the percentage by weight of the liquid crystal material in the third liquid crystal composite layer may be about 95 wt %.

Some embodiments include a liquid crystal composite, wherein the polymer material can be a soft polymer. In some embodiments, the soft polymer material can comprise polydimethylsiloxane.

In some embodiments, the liquid crystal composite can comprise a nematic liquid crystal material. In some embodiments, the liquid crystal material can be a negative anisotropic material.

Some embodiments include a method for making a reverse anisotropy window. In some embodiments, the method can comprise; 1) filling a cell with the aforedescribed liquid crystal composite; 2) heating the filled cell above a nematic-isotropic transition temperature for the liquid crystal material; and 3) cooling the filled cell below the isotropic-nematic transition temperature placing the liquid crystal material in the nematic phase create an annular gap between the cured polymer and liquid crystal material.

In some embodiments, a liquid crystal element can comprise: a transparency changing layer comprising the liquid crystal composite; a first alignment layer disposed on a first opposing surface of the transparency changing layer; and a second alignment disposed on a second opposing surface of the transparency changing layer. Thus, the transparency changing layer is between, e.g. sandwiched between, the first alignment layer and the second alignment layer.

Some embodiments include a selectively dimmable device comprising the liquid crystal element disposed between a first conductive substrate and a second conductive substrate. Some embodiments comprise a voltage source. In some embodiments, the first conductive substrate, the second conductive substrate, the liquid crystal element, and the voltage source can all be in electrical communication such that when a voltage is generated from the voltage source an electric field is applied across the element. In some embodiments, the selectively dimmable device can have a haze of at most 5% when there is no voltage applied but a haze of at least 80% when a voltage of 25 volts or more is applied across the device.

These and other embodiments are described in greater detail below.

### BRIEF DESCRIPTION OF THE DRAWINGS

FIG. 1 is a depiction of a liquid crystal element with a liquid crystal with negative dielectric anisotropy.

FIG. 2 is a depiction of an embodiment of a selectively dimmable device with a negative dielectric anisotropic with no applied voltage field.

FIG. 3 is a depiction of an embodiment of a selectively dimmable device with a negative dielectric anisotropic with an applied voltage field.

FIG. 4A is a picture showing a multilayered liquid crystal element positioned in the polarizing microscope with no applied voltage.

FIG. 4B is a picture showing the phase separated liquid crystal composition of a multilayered liquid crystal element positioned in the polarizing microscope

FIG. 5 is a plot showing the haze as a function of voltage of an embodiment described herein.

FIG. 6 is a plot showing the haze as a function of voltage of an embodiment described herein.

FIG. 7 is a plot showing the haze as a function of voltage of an embodiment described herein.

FIG. 8 is a plot showing the current and haze as a function of voltage of an embodiment herein.

FIG. 9A is a picture showing the polarizing microscope image of an embodiment at 0 volts.

FIG. 9B is a picture showing the polarizing microscope image of an embodiment at 5 volts.

FIG. 9C is a picture showing the polarizing microscope image of an embodiment at 10 volts.

FIG. 9D is a picture showing the polarizing microscope image of an embodiment at 30 volts.

### DETAILED DESCRIPTION

The terms “positive dielectric anisotropy”, “negative dielectric anisotropy”, and “neutral dielectric anisotropy” as used herein all have meanings known by those of ordinary skill in the art. The dielectric anisotropy is related to dielectric properties as well as optical properties depending on the direction, either along the length of the molecule (or molecular axis), or perpendicular to the length of the molecule (or molecular axis). The dielectric properties depend on the molecular shape and substituent moieties and their locations on a given molecule.

A molecule is said to have a positive dielectric anisotropy if the dielectric constant parallel to the length of the molecule is greater than the dielectric constant perpendicular to the length of the molecule, where the length of a molecule is defined as vector between the two farthest moieties.

A molecule is said to have a negative dielectric anisotropy if the dielectric constant perpendicular to the length of the molecule is greater than the dielectric constant parallel to the length of the molecule, where the length of a molecule is defined as vector between the two farthest moieties.

A molecule is said to have a neutral dielectric anisotropy if the dielectric constant perpendicular to the length molecule is approximately the same as the dielectric constant parallel to the length of the molecule, where the length of a molecule is defined as vector between the two farthest moieties. Approximately the same is less than a 1% difference between dielectric constants.

The term “opposing surfaces” includes surfaces one opposite sides of a layer (e.g. top and bottom surfaces). When used in singular, the term “opposing surface” refers to one of the two surfaces.

The term “mesogenic” as used herein has the broadest meaning generally understood in the art, and may refer to intermediate state of a liquid crystal composition wherein the composition is not in a solid state nor in the liquid state but rather in an intermediate phase in between.

The term “nematic” as used herein has the broadest meaning generally understood in the art, and may refer to liquid crystals are composed of rod-like molecules with the long axes of neighboring molecules aligned approximately to one another.

The term “isotropic” as used herein, has the broadest meaning generally understood in the art, and may refers to the random orientation of the liquid crystals impregnated in the polymer matrix.

The term “reverse-mode” as used herein refers to a liquid crystal element that is in a substantially clear or optically transmissive state when no potential difference or voltage is applied to the liquid crystal element, and substantially opaque or optically non-transmissive when a potential difference or voltage is applied.

The term “fluid phase” as used herein refers to a state of matter wherein the liquid crystal is more liquid as opposed to solid.

The current disclosure describes a liquid crystal composition, a reverse-mode polymer dispersed liquid crystal (PDLC) element, and a selectively dimmable device based on the aforementioned element.

### Liquid Crystal Composite

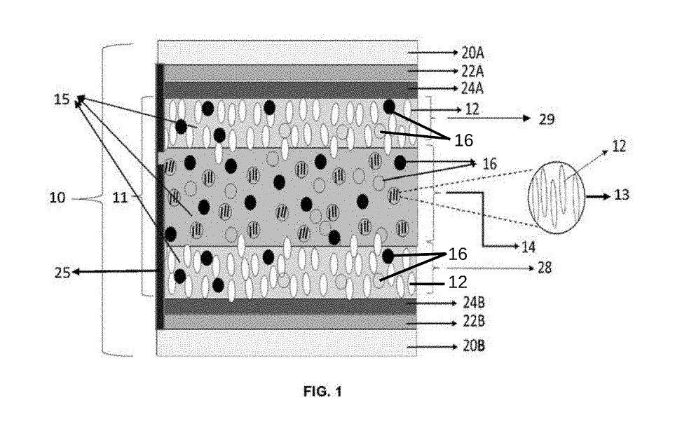

As shown in FIG. 1, the liquid crystal composition can comprise a first liquid crystal composite layer, e.g. first liquid composite layer 28. The first liquid crystal composite layer, such as first liquid composite layer 28, may include and a polymer, e.g. polymer 15, and a liquid crystal material. The liquid crystal material in the first liquid crystalline composite layer may be in the form of oblong irregular shapes such as, such as shape 12, or in another irregular form. The first liquid crystal composite layer may be substantially fluid. In some embodiments, the liquid crystal composite can comprise a second liquid crystal composite layer, such as second liquid crystal composite layer 14, which may the liquid crystal material. The liquid crystal material in the second liquid crystal composite layer may be in a different form than that of the first liquid crystal composite layer. For example, the liquid crystal material in the second liquid crystal composite layer may be in the form of a plurality of liquid crystal domains, such as liquid crystal domain 13, which are encapsulated and heterogeneously distributed within the solid polymer. In some embodiments, an annular space can be present between the fluid liquid crystal and the polymer. In some embodiments, the liquid crystal composite can comprise a third liquid crystal composite layer, such as third liquid crystal composite layer 29. The third liquid crystal composite layer, such as third liquid composite layer 29, may include and the polymer, e.g. polymer 15, and the liquid crystal material. The liquid crystal material in the third liquid crystalline composite layer may be in the form of oblong irregular shapes such as, such as shape 12, or in another irregular form. The third liquid crystal composite layer may be substantially fluid. In some embodiments, a liquid crystal composite has both fluid/liquid and crystalline characteristics.

In some embodiments, the liquid crystal composite can further comprise an ionic compound, (which can generate both cations (black circles), and anions (clear circles)), such as anion 16 depicted in FIG. 1. In some embodiments, the ionic compound can comprise a quaternary ammonium salt. In some embodiments, the quaternary ammonium salt can be comprised of a quaternary ammonium cation and a halide anion. In some embodiments, the halide anion can be a bromide. In some embodiments, the quaternary ammonium salt can be comprised of cetyltrimethyl-ammonium bromide (CTAB) or hexadecyltrimethyl-ammonium bromide (HTAB). In some embodiments, the liquid crystal composite can comprise one or more liquid crystal materials. In some embodiments, the liquid crystal composite can exhibit a mesogenic liquid crystal phase. In some embodiments, the liquid crystal composite can comprise a compound with positive dielectric anisotropy. In some embodiments, the liquid crystal composite can comprise a compound with negative dielectric anisotropy. In some embodiments, the liquid crystal composite can comprise both a compound with positive dielectric anisotropy and a compound with negative dielectric anisotropy.

Some embodiments include a liquid crystal composite comprising a plurality of liquid crystal layers, such as a first liquid crystal composite layer, a second liquid crystal composite layer, a third liquid crystal composite layer, etc.

A first liquid crystal composite layer may contain any suitable amount of polymer, such as about 1 wt %, up to about 5 wt %, about 1 wt % to about 5 wt %, about 5-10 wt %, about 10-15 wt %, about 15-20 wt %, about 20-25 wt %, about 25-30 wt %, about 30-35 wt %, or about 20 wt % of the first liquid crystal composite layer.

A second liquid crystal composite layer may contain any suitable amount of polymer, such as about 1 wt % to about 5 wt %, about 5-10 wt %, about 10-15 wt %, about 15-20 wt %, about 20-25 wt %, about 25-30 wt %, about 30-35 wt %, about 35-40 wt %, about 40-45 wt %, about 45-50 wt %, about 50-55 wt %, about 55-60 wt %, about 60-65 wt %, about 65-70 wt %, about 70-75 wt %, about 75-80 wt %, about 80-85 wt %, about 85-90 wt %, about 95-99 wt %, or about 50 wt % of the second liquid crystal composite layer.

A third liquid crystal composite layer may contain any suitable amount of polymer, such as about 1 wt %, about 1 wt % to about 5 wt %, about 5-10 wt %, about 10-15 wt %, about 15-20 wt %, about 20-25 wt %, about 25-30 wt %, about 30-35 wt %, or about 20% of the third liquid crystal composite layer.

A first liquid crystal composite layer may contain any suitable amount of liquid crystal material, such as about 95 wt % to about 99 wt %, about 90-95 wt %, about 85-90 wt %, about 80-85 wt %, about 75-80 wt %, or about 70-75 wt % of the first liquid crystal composite layer.

A second liquid crystal composite layer may contain any suitable amount of liquid crystal material, such as about 1 wt %, about 1 wt % to about 5 wt %, about 5-10 wt %, about 10-15 wt %, about 15-20 wt %, about 20-25 wt %, about 25-30 wt %, about 30-35 wt %, about 35-40 wt %, about 40-45 wt %, about 45-50 wt %, about 50-55 wt %, about 55-60 wt %, about 60-65 wt %, about 65-70 wt %, about 70-75 wt %, about 75-80 wt %, about 80-85 wt %, about 85-90 wt %, about 95-99 wt %, or about 50% of the second liquid crystal composite layer .

A third liquid crystal composite layer may contain any suitable amount of liquid crystal material, such as about 95 wt % to about 99 wt %, about 90-95 wt %, about 85-90 wt %, about 80-85 wt %, about 75-80 wt %, about 70-75 wt %, about 65-70 wt %, or about 80% of the third liquid crystal composite layer.

In some embodiments, the liquid crystal composite can comprise a fluid liquid crystal material and a fluid polymer material. In some embodiments, at least one of the fluid liquid crystal material or fluid polymer material may be a liquid. In some embodiments, the liquid crystal material and the polymer material can be immiscible. Therefore, the liquid crystal material and the polymer material do not substantially (e.g. homogenously) mix with each other. In some examples, the liquid crystal material and the polymer material do not mix with each other to a certain degree. In some embodiments the liquid crystal material and the polymer material do not mix to substantially any degree. The immiscibility of the liquid crystal material and polymer material may be due to the properties of the liquid crystal material and polymer materials, for example their chemical compositions; the liquid crystal material and polymer material tend to remain separated from each other, therefore tending not to mix together to form a homogeneous mixture of the liquid crystal material and polymer material. Due to this immiscibility, the liquid crystal material and polymer materials may meet each other at an interface which defines a boundary between the volume (or layer) of substantially the fluid liquid crystal material and the volume (or layer) of substantially the polymer material; this interface or boundary may be referred to as a phase interface. With the liquid crystal material and the polymer material substantially not mixing with each other, it is envisaged in some examples that there may be some degree of mixing of the liquid crystal material and polymer material, but that this may be considered negligible in that the majority of the volume of liquid crystal material may not be mixed with the majority of the volume of the polymer material, but rather may be forced out of the polymer during curing and may form separate distinct fluid layers (e.g., a first liquid crystal composite layer and/or a third liquid crystal composite layer as described above).

In some embodiments, the first liquid crystal composite layer, can comprise at least one liquid crystal material. In some embodiments, the first liquid crystal composite layer can comprise at least one fluid liquid crystal material and the polymer. In some embodiments, the first liquid crystal composite layer can comprise up to about 5% wt of the polymer material.

In some embodiments, the second liquid crystal composite layer can comprise at least one liquid crystal material and the polymer. In some embodiments, the second layer can comprise up to about 50 wt % of the polymer. In some embodiments, the second liquid crystal composite layer can be disposed between the first liquid crystal composite layer and the third liquid crystal composite layer. In some embodiments, the second liquid crystal composite layer can comprise a liquid crystal material having a first level of hydrophobicity and a polymer material having a second level of hydrophobicity wherein the liquid crystal material and the polymer material are sufficiently different in hydrophobicity to form a plurality of liquid crystal domains which are encapsulated within the polymer material. In some embodiments, the physical parameter may be surface free energy, hydrophobicity, T_{g}, solubility, polarity, and/or contact angle.

In some embodiments, a liquid crystal composite can further comprise a third liquid crystal composite layer. In some embodiments, the third liquid crystal composite layer can comprise at least one fluid liquid crystal material and the polymer. In some embodiments, the third liquid crystal composite layer can comprise up to about 5% wt of the polymer material.

In some embodiments, the first liquid crystal composite layer and/or a third liquid crystal composite layer can comprise at least 95 wt % fluid liquid crystal and up to 5 wt % of polymer. In some embodiments, the polymer can contain polymer, anions, cations and an amount of liquid crystal composite. It is believed that the first liquid crystal composite layer and third liquid crystal composite layer may form due to a majority of the liquid crystal composite, e.g., fluid liquid crystal compound, being forced out of the polymer during the polymerization of the polymer precursors, while the liquid crystal composite that remains within the polymer forms suspended precipitates or separate liquid crystal phase domains. In some embodiments, the separate liquid crystal domains can have a uniform distribution, a gradient distribution, or a random distribution within the polymer. In some embodiments, the separate liquid crystal domains can have a random distribution within the polymer.

As shown in FIG. 1, a transparency changing layer, 11, can comprise a plurality of liquid crystal layers. In some embodiments, the transparency changing layer can comprise a first liquid crystal composite layer, e.g. first liquid crystal composite layer 28, a second liquid crystal composite layer, e.g. second liquid crystal composite layer 14, and/or a third liquid crystal composite layer, e.g. third liquid crystal composite layer 29. In some embodiments the second liquid crystal composite layer, e.g. second liquid crystal composite layer 14, can be disposed between the first liquid crystal composite layer, e.g. first liquid crystal composite layer 28, and the third liquid crystal composite layer, e.g. third liquid crystal composite layer 29. In some embodiments, the plural liquid crystal layers can be distinctive phase separated layers. In some embodiments, the distinctive phase separated layers can be distinguishable gradients within the liquid crystal element.

### Polymer Material

In some examples of the disclosure, the liquid crystal composite can comprise a polymer material. In some embodiments, the polymer material can comprise a soft polymer. In some embodiments, the soft polymer can be a polymer having a glass transition temperature (T_{g}) below the nematic transition temperature of the liquid crystal composite. In some embodiments, the soft polymer material can be an organosilicon material. In some cases, the organosilicon material can be an alkylsilane. In some embodiments, the alkylsilane can be polydimethylsilane (PDMS). In some examples, the PDMS may be a suitable commercially available embodiment, for example, Sylgard® 184 (Dow Corning, Midland, Mich. USA). It is believed that the soft polymer may contain a flexible backbone, comprised of a siloxane chain, which may allow for a reduced barrier of rotation, which in turn may allow for a more favorable diffusion of the liquid crystal materials in the matrix. It is believed that the silicon-oxygen bonds in the alkylsilane's backbone chain may be more open and may have greater flexibility over other polymers. This greater flexibility may be due to the freedom of rotation about the bonds in the siloxane backbone. For example, the energy required for rotation around the carbon-carbon bonds in polyethylene is about 13.8 kJ/mol: the energy required for rotation around the silicon-oxygen bonds in polydimethylsiloxane is about 3.3 kJ/mol.

Ionic Compound

In some embodiments a liquid crystal composite may be described, the liquid crystal composite may comprise an ionic compound (such as ionic compound 16, as shown in FIG. 1, wherein black circles represent cations and the white circles represent anions). In some embodiments, the ionic compound can be disposed upon the opposing or interior surface[s] of the alignment layer(s) (such as alignment layers 24A and/or 24B). In some embodiments, the ionic compound can be salt of a C₁₀-C₂₀ quaternary ammonium cation and a halide anion, e.g., a bromide anion. In some embodiments a liquid crystal composite may be described, wherein the quaternary ammonium salt can comprise CTAB or HTAB. It is believed that in the absence of an applied voltage some of the cations and anions may pool near the ITO surface, 22A and/or 22B, and some of the cations and anions may diffuse within the polymer material, 15. When voltage was applied to the device, high concentrations of the cations and anions may begin to migrate creating ion passages or streams through the different liquid crystal layers. This movement of the ions alters the uniaxial orientation of the liquid crystal material and liquid crystal domains resulting in a random orientation of the liquid crystal material and liquid crystal domain, which scatters incoming light resulting in high haze. This is known in the field as the dynamic scattering mode (DSM).

It is believed that the combination of DSM and the low barrier to rotation created by the silicon-oxygen back bone of the PDMS can contribute to the resulting high haze with a low driving voltage.

### Liquid Crystal Element

Some embodiments include a liquid crystal element, such as liquid crystal element 10. In some embodiments, the liquid crystal element can comprise a transparency changing layer, e.g. transparency changing layer 11, which may comprise the liquid crystal composite described herein, and a first opposing surface, e.g. first opposing surface 20A, and a second opposing surface, e.g. second opposing surface 20B. In some embodiments, the transparency changing layer can further comprise a first alignment layer, e.g. first alignment layer 24A, and a second alignment layer, e.g. second alignment layer 24B. In some embodiments, the first alignment layer may bound the first opposing surface, and the second alignment layer may bound the second opposing surface. In some embodiments, the transparency changing layer's opposing surfaces are also the transparency changing layer's surfaces that have the greatest surface area. In some embodiments, any of the aforementioned layers can further comprise a spacer, a dispersant, a plasticizer, a binder, a solvent, or any combination thereof.

In some embodiments, the transparency changing layer can comprise any of the aforedescribed liquid crystal composites. In some embodiments, the transparency changing layer can comprise any of the aforedescribed first liquid crystal composite layer, second liquid crystal composite layer and/or third liquid crystal composite layer. In some embodiments, the second liquid crystal composite layer may be a liquid crystal material heterogeneously distributed in a solid polymer. It is believed that the heterogeneous distribution of the liquid crystal composite may minimize and/or reduce the liquid crystal networking facilitating the ability of the liquid crystals to rotate or orientate and thus may increase in opacity. In some embodiments, (e.g. as shown in FIG. 1) the liquid crystal composite can be heterogeneously distributed within the second liquid crystal composite layer, e.g. second liquid crystal composite layer 14, such that the liquid crystal materials form separate liquid crystal phase domains, e.g. crystal phase domains 13, suspended within the polymer. In some embodiments, the separate liquid crystal phase domains can be in the form of droplets, oblong shapes, or spheres. In some embodiments, the second liquid crystal composite layer may be a heterogeneous mixed liquid crystal/polymer. In some embodiments, the transparency changing layer can further comprise a sealant, such as sealant 25.

In some embodiments, the liquid crystal element can be opaque to visible light but turn transparent upon the application of an electric field, or a normal mode. In some embodiments, the liquid crystal element can be transparent to visual light but opaque upon the application of an electric field, or a reverse-mode element. In some embodiments, the liquid crystal element can be characterized as a reverse-mode heterogeneously mixed liquid crystal polymer dispersed element.

In some embodiments, the liquid crystal material has a birefringence Δn(589 nm, 20° C.) is about 0.1-0.2, about 0.1-0.15, about 0.15-0.2, about 0.1-0.11, about 0.11-0.12, about 0.12-0.13, about 0.13-0.14, about 0.14-0.15, about 0.15-0.16, about 0.16-0.17, about 0.17-0.18, about 0.18-0.19, or about 0.19-0.2.

In some embodiments, the liquid crystal has a dielectric anisotropy, Δε(1 KHz, 25° C.), that is about −1 to −10, such as about −1 to about −2, about −2 to about −3, about −3 to about −4, about −4 to about −5, about −4 to about −5, about −5 to about −6, about −6 to about −7, about −7 to about −8, without −8 to about −9, about −9 to about −10, about −1 to about −3, about −3 to about −6, about −6 to about −9, or about −6 to about −10.

In some embodiments, the polymer dispersed liquid crystal composite layer (or layers) are described as the transparency changing layer.

In some embodiments, as shown in FIG. 1, the transparency changing layer, e.g. transparency changing layer 11, can comprise a liquid crystal material, e.g. liquid crystal material in the form of shape 12, and a polymer, e.g. polymer 15, where the liquid crystal material was heterogeneously distributed in the polymer as separated liquid crystal domains, e.g. liquid crystal domain 13. In some embodiments, the polymer can be a produce of polymerizing polymer precursors and initiators in situ. In some embodiments, the polymer precursors may comprise of monomers, oligomers, or any combination thereof, before polymerization. In some embodiments, the polymer can be Sylgard® 184 (Dow Corning, Midland, Mich., USA).

In some embodiments, the polymer can be a thermal-curing polymer.

In some embodiments, the polymer can be a photopolymer. In some embodiments, the photopolymer can comprise polymer precursors and a photoinitiator. In some embodiments, the polymer can be a thermoplastic polymer. In some embodiments, the thermoplastic polymer can comprise polymer precursors and a thermal initiator. In some embodiments, the photopolymer can comprise a UV-curable polymer or a visual light based photopolymer. In some embodiments, the polymer can comprise a combination of a thermoplastic polymer and a photo/UV-curable polymer. In some embodiments, the ratio of liquid crystal compound to polymer can be between about 20:1 wt % to about 1:1 wt %, about 19:1-20:1 wt %, about 18:1-19:1 wt %, about 17:1-18:1 wt %, about 16:1-17:1 wt %, about 15:1-16:1 wt %, about 14:1-15:1 wt %, about 13:1-14:1 wt %, about 12:1-13:1 wt %, about 11:1-12:1 wt %, about 10:1-11:1 wt %, about 9:1-10:1 wt %, about 8:1-9:1 wt %, about 7:1-8:1 wt %, about 6:1-7:1 wt %, about 5:1-6:1 wt %, about 4:1-5:1 wt %, about 3:1-4:1 wt %, about 2:1-3:1 wt %, about 1.1-2:1 wt %, 1.1 wt %, about 4:1 wt %, or about 3:1 wt %.

In some embodiments, the monomer can comprise Paliocolor® LC-242, Paliocolor® LC-756, Paliocolor® LC-1057, Merck RM 257. In some embodiments, the monomer can comprise BASF Paliocolor® LC-242. In some embodiments, the monomer can comprise Merck RM 257. In some embodiments, the monomer can comprise both BASF Paliocolor® LC-242 and Merck RM 257.

In some embodiments, the photoinitiator can comprise a UV irradiation photoinitiator. In some embodiments, the photoinitiator can also comprise a co-initiator. In some embodiments, the photoinitiator can comprise an ionic photoinitator. In some embodiments, the ionic photoinitiator can comprise a benzophenone, camphorquinone, fluorenone, xanthone, thioxanthone, benzyls, a-ketocoumarin, anthraquinone, terephthalophenone, and any combination thereof. In some embodiments, the photoinitiator can comprise Igracure® 651. It is believed that co-initiators are thought to be employed to control the curing rate of the original pre-polymer such that material properties may be manipulated.

In some embodiments, the thermal-initiator can comprise: 4,4′-azobis(4-cyanovaleric acid) (ACVA); a,a-azobisisobutyronitrile; 1,1′-azobis(cyclohexanecarbonitrile) (ACHN); ammonium persulfate. These thermal-initiators are intended for illustration purposes, and it is envisioned that any suitable thermal-initiator can be used. In some embodiments, the thermal-initiator can be incorporated in the commercially available polymer mix, for example: part B of the two part Sylgard® 184 (Dow Corning).

In some embodiments, the liquid crystal element can also comprise an ionic compound. In some embodiments, the ionic compound can comprise CTAB and/or HTAB.

In some embodiments, a spacer can be used to control the thickness of the liquid crystal element (i.e. defining the gap between the two alignment layers and the conducting substrates). In some embodiments, the spacers provide structural support to ensure a uniform thickness of the liquid crystal element. In some embodiments, the spacers can be in the form of beads. In some embodiments, the spacers can comprise silica dioxide or glass, or a polymer, such as divinylbenzene, polymethylmethacrylate, polybutylmethacrylate, polymethylsilsesquioxane, polylaurylmethacrylate, polyurethane, polytetrafluoroethylene (Teflon), benzocyclobutene (BCB), amorphous fluoropolymer (Cytop), perfluorocyclobutene, or combinations thereof.

A bead may have any appropriate diameter depending upon the desired spacing characteristics sought. For example, the beads may have an average diameter of about 1-60 μm, about 1-50 μm, about 1-5 μm, about 10 μm or about 15 μm to about 20 μm or to about 50 μm; about 1-2 μm, about 2-3 μm, about 3-4 μm, about 4-5 μm, about 5-6 μm, about 6-7 μm, about 7-8 μm, about 8-9 μm, or about 9-10 μm; about 10-11 μm, about 11-12 μm, about 12-13 p.m, about 13-14 μm, about 14-15 μm, about 15-16 μm, about 16-17 μm, about 17-18 μm, about 18-19 μm, or about 19-20 μm; about 20-21 μm, about 21-22 μm, about 22-23 μm, about 23-24 μm, about 24-25 μm, about 25-26 μm, about 26-27 μm, about 27-28 μm, about 28-29 μm, or about 29-30 μm; about 30-31 μm, about 31-32 μm, about 32-33 μm, about 33-34 μm, about 34-35 μm, about 35-36 μm, about 36-37 μm, about 37-38 μm, about 38-39 μm, or about 39-40 μm; about 40-41 μm, about 41-42 μm, about 42-43 μm, about 43-44 μm, about 44-45 μm, about 45-46 μm, about 46-47 μm, about 47-48 μm, about 48-49 μm, or about 49-50 μm; about 50-51 μm, about 51-52 μm, about 52-53 μm, about 53-54 μm, about 54-55 μm, about 55-56 μm, about 56-57 μm, about 57-58 μm, about 58-59 μm, or about 59-60 μm. In some embodiments, the spacers can be dispersed in a random distribution. In some embodiments, the spacers can be dispersed uniformly. In some embodiments, the liquid crystal element may contain spacers with an average spacer density ranging from about 10 spacers/in² to about 1000 spacers/in². In some embodiments, the liquid crystal element may contain spacers with an average spacer density of about 10 spacers/in², about 20 spacers in^{t}, about 25 spacers/in², about 50 spacers/in² to about 100 spacers/in², about 200 spacers/in², about 500 spacers/in², or about 1000 spacers/in², or any density in a range bounded by any of these values.

An alignment layer, such as a first alignment layer or a second alignment layer, can be a layer that may help to align a liquid crystal composite. The alignment layer may be composed of any suitable alignment material, or a material that can help with this alignment. In some embodiments, the alignment layers can comprise a polyimide, such as, LX-1400.

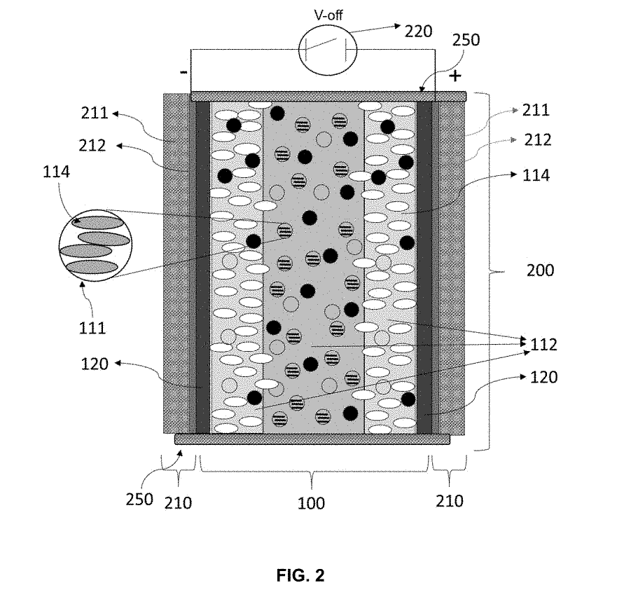

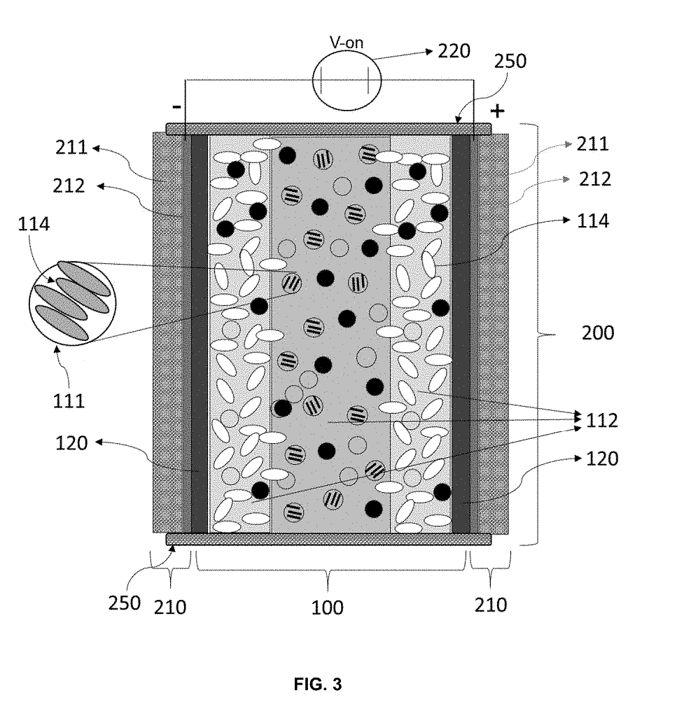

In some embodiments, when a voltage is applied across the element, the liquid crystals may rotate from their pre-tilt positions in response to the application of an electric field resulting in a change of index of refraction due to the change in orientation of the individual liquid crystal material, e.g. liquid crystal material 114, or the liquid crystal domains, e.g. liquid crystal domains 111, (FIGS. 2 and 3). The change in the liquid crystal index of refraction within the suspended liquid crystal domains, e.g. liquid crystal domains 111 (FIGS. 2 and 3), can result in an index of refraction mismatch between the liquid crystal domains and the polymer resulting in a haze or loss of transparency in the element due to light scatter. In some embodiments, where the liquid crystal materials may be characterized as having a negative dielectric anisotropy, the polyimide alignment layer can be chosen such that the aforementioned liquid crystal material is homeotropically aligned with the substrate, or oriented perpendicularly to the substrate, as shown in FIG. 1, when there is no voltage applied. In some embodiments, the homeotropic-alignment polyimide can comprise a polyimide that has a pre-tilt angle of about 85 degrees to about 90 degrees. In some embodiments the homeotropic-alignment polyimide can comprise a polyimide that has a pre-tilt angle of about 90 degrees.

In some embodiments, the liquid crystal element can also comprise dispersants such as an ammonium salt, e.g., NH₄Cl; Flowlen; fish oil; ablong chain polymer; steric acid; oxidized Menhaden Fish Oil (MFO); a dicarboxylic acid such as, but not limited to, succinic acid, ethanedioic acid, propanedioic acid, pentanedioic acid, hexanedioic acid, heptanedioic acid, octanedioic acid, nonanedioic acid, decanedioic acid, o-phthalic acid, and p-phthalic acid; sorbitan monooleate; and mixtures thereof. In some embodiments, the dispersant can comprise oxidized MFO.

In some examples, the liquid crystal element can also comprise a solvent as part of the method of synthesizing the element. In some embodiments, the solvent can comprise a polar solvent. In some embodiments, the polar solvent can comprise water. In some embodiments, the solvent may comprise a non-polar solvent. In some embodiments, the non-polar solvent may be an organic solvent. In some embodiments, the non-polar solvent may include, but is not limited to, a lower alkanol such as, but not limited to, ethanol, methanol, isopropyl alcohol, xylenes, cyclohexanone, acetone, toluene and methyl ethyl ketone, and mixtures thereof. In some embodiments, the non-polar solvent may be toluene.

### Selectively Dimmable Device

A liquid crystal element may be incorporated into a selectively dimmable device. The selectively dimmable device can comprise the liquid crystal element disposed between a first conductive substrate and a second conductive substrate. A selectively dimmable device also includes a voltage source which can be configured so that the substrates, the element and the voltage source are all in electrical communication such that when a voltage is applied by the voltage source, an electric field is applied across the liquid crystal element.

As shown in FIGS. 2 and 3, the selectively dimmable device, e.g. selectively dimmable device 200, can comprise: at least two conductive substrates, e.g. conductive substrates 210, the aforedescribed liquid crystal element, e.g. liquid crystal element 100, and a voltage source, e.g. voltage source 220. In some embodiments, the first conductive substrates and the second conductive substrate can comprise a base, e.g. base 211. In some embodiments, the base can be conductive. In some embodiments, each first conductive substrate and the second conductive substrate can comprise an electron conductive layer, e.g. electron conductive layer 212, in addition to the base, where the electron conduction layer may be in physical communication with the base. In some embodiments, electron conduction layers and the base can be non-conductive. In some embodiments, the selectively dimmable device can comprise a sealant, e.g. sealant 250, to protect the liquid crystal element from the environment. In some embodiments, the selectively dimmable device can further comprise an adhesive layer and a removable backing to allow application to existing windows.

In some embodiments, each conductive substrate can further comprise an electron conduction layer, where the layer can be in physical communication with the base. In some embodiments the electron conduction layer can be comprised of indium tin oxide (ITO) or indium zinc oxide (IZO). In some embodiments, the electron conduction layer can be placed in direct physical communication with the base, such as a layer on top of the base. In other embodiments, the electron conduction layer may be impregnated directly into the base (e.g. ITO glass), or sandwiched in between two bases to form a single conductive substrate. Some embodiments can comprise an electron conducting layer present in a base comprised of a non-conductive material. In some embodiments, non-conductive material can comprise glass, polycarbonate, polymer, or combinations thereof. In some embodiments, the substrate polymer can comprise polyvinyl alcohol (PVA), polycarbonate (PC), acrylics including, but not limited to, poly(methyl methacrylate) (PMMA), polystyrene, allyl diglycol carbonate (e.g. CR-39), polyesters, polyetherimide (PEI) (e.g. Ultem®), Cyclo Olefin polymers (e.g. Zeonee), triacetylcellulose (TAC), polyethylene terephthalate (PET), polyethylene naphthalate (PEN), or polyvinyl butyrate, polyvinyl cyclohexanal, amorphous polyethylene, Latex, NOA65™, SU-8™, or any combination thereof. In some embodiments, the substrate can comprise polyethylene terephthalate (PET), polyethylene naphthalate (PEN), or a combination thereof. In some embodiments, the electron conduction layer can be comprised of a transparent conductive oxide, conductive polymer, metal grids, carbon nanotubes (CNT), graphene, or a combination thereof. In some embodiments, the transparent conductive oxide can comprise a metal oxide. In some embodiments, the metal oxide can comprise iridium tin oxide (IrTO), indium tin oxide (ITO), fluorine doped tin oxide (FTO), doped zinc oxide, or combinations thereof. In some embodiments, the metal oxide can comprise indium tin oxide incorporated onto the base, e.g. ITO glass, ITO PET, or ITO PEN.

In some embodiments, the first conductive substrate and second conductive substrates can define a gap, where the liquid crystal element can be disposed in the gap between the first conductive substrate and second conductive substrate.

As shown in FIGS. 2 and 3, in some embodiments of the selectively dimmable device, the liquid crystal element, which can comprise a polymer matrix, e.g. polymer matrix 112, with suspended liquid crystal domains, e.g. liquid crystal domains 111, comprising the liquid crystal material, e.g. liquid crystal material 114, are all bounded by two alignment layers, e.g. alignment layers 120. In some embodiments of the selectively dimmable device, the liquid crystal domains can comprise a negative dielectric anisotropic compound. In other embodiments of the selectively dimmable device, the liquid crystal domains can comprise positive dielectric anisotropic compounds. In still other embodiments of the selectively dimmable device, the liquid crystal domains can comprise a combination of positive and negative dielectric anisotropic compounds.

In some embodiments of the device, the liquid crystal element can be chosen such that under a condition when no induced electric field is present (e.g. no voltage), within the transparency changing layer, the index of refraction of the liquid crystal composite and the index of refraction of the polymer are similar, relative to each other so that the total transmission of visible light allowed to pass through the device can be at least about 70%, about 70% to about 75%, about 75%-80%, about 80-85%, about 85-90%, about 90-95%, about 95-98%, or at least about 98%. In some embodiments, when there is an electric field present, e.g. due to a voltage applied to the electrical circuit, the index of refraction of the liquid crystal and the index of refraction of the polymer can vary relative to each other so that incident light is scattered and at most only about 40%, only about 35% to about 40%, only about 30-35%, only about 25-30%, only about 20-25%, only about 15-20%, only about 10-15%, only about 5-10%, or only about 0-5% of visible light is allowed to pass through the device. In some embodiments, the magnitude of the electric field necessary achieve scattering corresponds to applying a voltage of less than 120 V, less than 110 V, less than about 50 V, less than about 45 V, less than about 40 V, less than about 35 V, less than about 30 V, less than about 25 V, less than about 20 V, less than about 15 V, less than about 12 V, less than about 10 V, or a voltage of less than about 5V across the device. In some embodiments, the electric field across the device is less than about 500 kV/m, less than about 1,000 kV/m, less than about 5,000 kV/m, less than about 10,000 kV/m, less than about 20,000 kV/m, less than about 40,000 kV/m to less than about 80,000 kV/m. It is believed that the effectiveness of dimming of the device can also be depicted in terms of percentage of haze, which generally can be defined as:

$$Haze [ \% ] = \frac{Total Light Transmitted - Diffuse Light Transmitted}{Total Light Transmitted} \times 100 \% ,$$

where the total light transmitted is the light from a known source and the diffuse light transmitted is the light transmitted through the element. In some embodiments, the haze of the device can be about 0-0.5%, about 0.5 to about 1%, about 1-2%, about 2-3%, about 3-4%, about 4-5%, or about 5%, when no voltage is applied to the device. In some embodiments, the haze of the device can be at least about 70%, about 70% to about 75%, about 75-80% about 80-85%, about 85%-90%, about 90-100%, or at least 90%, when a voltage of 15 volts or more is applied to achieve scattering. In some embodiments, the haze of the device can be at least about 70% when the voltage is about 20 V. In some embodiments, the haze of the device can be at least 85% when the voltage is about 25 V. In some devices, the haze can be about 88% when the voltage is about 30 V.

In some embodiments, the selectively dimmable device can be semi-rigid or rigid. In some embodiments, the selectively dimmable device can be flexible. In some embodiments, a selectively dimmable device can form a flexible sheet which can be applied between or on the surface of preexisting windows. In some embodiments, the conductive substrates can comprise flexible materials so that the aforementioned device may be a flexible film. In some embodiments, the flexible device may be placed in between or on one side of pre-existing window glass to provide a dimming capability. In other embodiments, the base can comprise inflexible materials.

In some embodiments, the conductive substrates can comprise a base. In some embodiments, the base can comprise a conductive material. In some embodiments, the conductive material can comprise conductive polymers. In some embodiments, the conductive polymers can comprise poly(3,4-ethylenedioxythiophene) (PEDOT), PEDOT: poly(styrene sulfonate) (PSS), or any combination thereof.

In some embodiments, a dopant can be added to the polymer matrix to increase the mechanical strength of the flexible device. In some embodiments, the dopant can be inorganic oxides, SiO₂, Sb₂O₅, typical size can be 5-20 nm. In some embodiments, the dopant can be graphene oxide, carbon nanotubes, or C₆₀.

In some embodiments, the selectively dimmable device can comprise a sealant. In some embodiments, the sealant can encapsulate the liquid crystal element between the conductive substrates to protect the element from the environment. In some embodiments, the sealant can comprise a two-part real time cure epoxy, 3-Bond 2087, or the like. In some embodiments, the sealant can comprise a UV-curable photopolymer, such as NOA-61, or the like. In some embodiments, the selectively dimmable device can also comprise an adhesive layer. In some embodiments, the adhesive layer will allow a flexible sheet embodiment of the aforementioned device to be installed on pre-existing windows. In some embodiments, the adhesive can comprise an optically clear adhesive (OCA). In some embodiments, the OCA can comprise OCA products commercially available and known to those skilled in the art (e.g. Nitto OCA tape, Scapa OCA tape). In some embodiments, the selectively dimmable device can also comprise a removable carrier substrate to protect the adhesive layer from contamination which will be peeled away before the device's application.

Some embodiments include a method for making a reverse anisotropy window. The method can comprise filling a cell with the aforedescribed liquid crystal composite; heating the filled cell above the nematic-isotropic transition temperature for the liquid crystal material; and cooling down the filled cell below the isotropic-nematic transition temperature to place the liquid crystal material in the nematic phases and create an annular gap between the cured solid phase polymer and fluid phase liquid crystal material. Those skilled in the art will recognize that various compounds have had their respective transition temperature published. For example, where the liquid crystal material used is QYPDLC-201309 (Qingdao QY Liquid Crystal Co., Ltd., Chengyang Qingdao China), the nematic transition temperature can be about 90° C.

In some embodiments, the method can comprise assembling and or providing a light transmissive element. In some embodiments, the light transmissive element can comprise a first and second light transmissive element, the light transmissive elements defining a space therebetween. In some embodiments the light transmissive elements can be glass or a transparent polymer.

In some embodiments, the method can comprise heating the filled liquid crystal composite to a temperature above the nematic isotropic transition temperature for the liquid crystal material. In some embodiments, the liquid crystal composite can be heated to a temperature between 90° C. and 150° C. In some embodiments, at least a first layer of liquid crystal material is formed adjacent (as opposed to distal), to the cell defining element, e.g., the glass substrates. In some embodiments, the heating of the materials results in the curing of the polymer material. In some embodiments, the heating of the materials results in the thermal-expansion and/or the occupation of more volume by the liquid crystal material. In some embodiments, the volume of the polymer material, e.g. PDMS, shrinks during the thermal-curing of the polymer material.

In some embodiments, the method can comprise cooling the polymer material and the liquid crystal material to a temperature below the isotropic-nematic transition temperature. In some embodiments, a space is defined between the cured polymer material and the liquid crystal material. It is believed that the space reduces the intra-liquid crystal networking, facilitating the ease of liquid crystal alignment. It is believed the space increases the haze that can be generated by the respectively made liquid crystal element.

### EXAMPLES

It has been discovered that embodiments of the liquid crystal composite and related reverse-mode liquid crystal elements and devices described herein provide the ability for a selectively dimmable surface. These benefits are further shown by the following examples, which are intended to be illustrative of the embodiments of the disclosure, but are not intended to limit the scope or underlying principles in any way.

### Example 1

### Fabrication of LC-Based Dimmable Device Using Capillary Method

A selectively dimmable device based on a liquid crystal compound with negative dielectric anisotropy was fabricated using the capillary method. For the capillary method, a Homeotropic type liquid crystal test cell (KSHH-10/B107M1NSS05, E.H.C Co. Ltd, Tokyo, Japan) was used for making the device. The test cell comprised of two substrates with supports that defined an active alignment area in between the two substrates. The size of the glass/ITO substrate was 20 mm×25 mm with a sheet resistance about 100 Ω/sq and the active alignment area was about 10 mm×10 mm with a cell gap of 10 μm. The cell was procured pre-coated with a cetyltrimethyl-ammonium bromide (CTAB, Tokyo Chemical Industries, Tokyo, Japan) with a tilting angle of about 85 to about 90 degrees. Also, because of the geometry the cell included supports to ensure preservation of the cell gap, separate spacers were not required to be inserted into the cell before application of the liquid crystals.

First, the test cell was baked at 120° C. (about 40° C. above the nematic transition temperature) for 30 min before injection of liquid crystal mixture to remove any moisture vapors or impurities present inside the test cell. The liquid crystal composite was then prepared by first mixing QYPDLC-201309 (Qingdao QY Liquid Crystal Co., Ltd., Chengyang Qingdao China) with a soft polymer (Sylgard 184 Silicone Elastomer, Dow Corning, Mich., USA) weight ratio of about (70 to 90 wt %) to about 10 wt % respectively. Sylgard 184 Silicone Elastomer is a two-part composition. Part-A is polydimethylsiloxane and Part-B is hexachloroplatinate (cross-linking agent). At first QYPDLC-201309 was added to Part-A and mixed, using a vortex mixer and ultrasonic homogenizer to mix the composition thoroughly. Next, the Part-B was added to the mixture and mixed with using a vortex mixer and ultrasonic homogenizer. The ratio of Part-A and Part-B in the elastomer was 10:1. The coating formulation thus ready for injection into cell. Additional test samples were made in the same manner, except that the amount of polymer to liquid crystal weight % was varied from 5 wt % to 35 wt %, in 5 wt % intervals (i.e. 5 wt %, 10 wt %, 15 wt %, 20 wt %, 25 wt %, 30 wt % and 35 wt %).

The test cell was next pre-treated for the liquid crystal injection by warming the substrates at 80° C. for 5 minutes on a hot plate. Then, the liquid crystal composite was injected near the opening of the test cell. The solution was then allowed to enter into the test cell by capillary action until it coated the entire active alignment area. The test cell was put on hot plate after injecting liquid crystal composite to help ensure homogenous coverage of the liquid crystal.

Then, the layered cell assembly was cured by placing the assembly inside an oven at 85° C. overnight. Alternatively, the layered cell assembly can be fast cured at 105° C. for 35 minutes or 150° C. for 10 minutes. The layered cell assembly was then cooled below the isotropic-nematic transition temperature. The result was an unsealed, dimmable assembly.

After thermal curing process, the edges were sealed with a sealant to protect the liquid crystal element. After encapsulation, the assembly was then baked in an oven at 80° C. for 30 minutes, which resulted in a sealed, dimmable assembly.

The sealed dimmable assembly was placed in electrical communication with a voltage source by attaching a conducting clamp and wire to each conductive substrate such that when a voltage was applied across the voltage source, an electrical field was applied across the liquid crystal.

### Example 2

### Fabrication of LC-Based Dimmable Device Using Capillary Method: Comparative Example

A selectively dimmable device based on a liquid crystal compound with negative dielectric anisotropy was fabricated using the capillary method. A Homeotropic type liquid crystal test cell (KSHH-10/B107M1NSS05, E.H.C Co. Ltd, Tokyo, Japan) was used for making the device. The test cell was comprised of two opposing glass/ITO substrates, with supports, that define an active alignment area located within gap created by the two opposing substrates. The glass/ITO substrate measure 20 mm×25 mm with a sheet resistance about 100 Ω/sq and the active alignment area was about 10 mm×10 mm and a cell gap of 10 μm. The test cell was pre-coated with a cetyltrimethyl-ammonium bromide (CTAB, Tokyo Chemical Industries, Tokyo, Japan) with a tilt angle about 90 degrees.

Prior to the incorporation of the liquid crystal composite, the test cell was baked at 120° C. for 30 min to remove any impurities or moisture vapors present inside the chamber. The liquid crystal composite was prepared by mixing QYPDLC-201309 (Qingdao QY Liquid Crystal Co., Ltd., Chengyang Qingdao China) with Paliocolor® LC-242, a reactive mesogen, (BASF Corporation, Florham Park, N.J., USA) weight ratio of about (70 to 90wt %) to about 10 wt % respectively. A photoinitiator, Irgacure 651 (BASF) was mixed with LC-242 at 1 wt %, with a vortex mixer to make a homogeneous mixture. The mixture was then heated on heating block at about 100° C. until the solution cleared, followed by vortexing. After several heating and vortexing procedures, the liquid crystal composite was ready for injection into cell. Additional test samples were made using the same methods, except the weight % of the polymer to liquid crystal were varied from 5 to 30 wt %.

Next, the test cells were pre-treated, for liquid crystal composite injection, by warming the glass/ITO substrates at 100° C. for 5 minutes on a hot plate. Then, the liquid crystal composite was injected into the opening of the test cell. The solution was allowed to enter into the test cell by capillary action until the entire active alignment area was coated. In some embodiments, to help ensure a homogenous coverage of the liquid crystal composite, the test cell was put on hot plate after injecting the liquid crystal composite.

To prevent overheating of the test cell during UV curing, the completed test cell assembly was placed on a stainless steel plate to provide a thermal sink. The test cell assembly was then cured under a UV LED (365 nm, Larsen Electronics, Kemp, TX USA) at an output of about 50 mW/cm² incident power for about 1.5 minute on each side to photo polymerize the LC-242. To prevent localized blooming, a by-product of the UV irradiation, the test cells assembly's orientation switched at approximately 3-minute intervals by flipping the assembly over. The result was an unsealed, dimmable assembly.

After the UV curing process, the edges were sealed with a sealant to protect the liquid crystal element. After encapsulation, the assembly was then baked in an oven at 80° C. for 30 minutes, resulting in a sealed, dimmable assembly.

The sealed dimmable assembly was placed in electrical communication with a voltage source by attaching a conducting clamp and wire to each conductive substrate such that when a voltage was applied across the voltage source, an electrical field was applied across the liquid crystal.

### Example 3.1

### Measurement of Device Haze

The optical characteristics of the fabricated dimmable devices were characterized by measuring the light allowed to pass through each, with and without an electric field present. An electrical connection was achieved by connecting wires to each terminal of the voltage source and to the respective glass/ITO substrates on the device such that an electric field would be applied across the device when the voltage source was energized or a voltage applied, and then placed into the haze meter. For the measurement of haze, an automated haze measurement system was built in-house. A haze meter (NDH-7000; Nippon Denshoku, Tokyo, Japan) was used to measure the total transmittance (Tₜ), parallel transmittance (Tₚ) and diffuse transmittance (Td). AC voltage was supplied from a voltage supplier (HP 8116A, Pulse/Function Generator, Hewlett Packard, Calif., USA) and amplified by a bipolar operational power supply/amplifier (BOP-500M, KEPCO, NY, USA). Voltage was supplied to the device and haze measured after 10s interval time. Proprietary software was used for data acquisition. The source light was directly measured without any sample present to provide a baseline measurement of total light transmitted. Then, the samples were placed directly in the light path of the haze meter and the haze was measured both with increasing voltage and then with decreasing voltage, at 5 volt intervals, from 0 volts to 40 volts (voltage ramp up) and then 40 volts back to 0 volts (voltage ramp down).

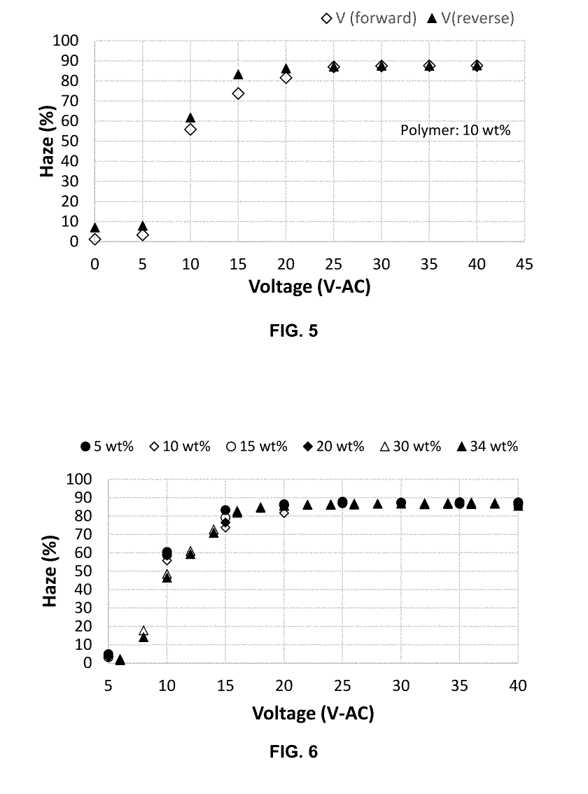

FIG. 5 shows the resulting % haze at increasing voltages (voltage ramp up) and % haze at decreasing voltages (voltage ramp down); the results indicate that the device has little to no hysteresis (voltage ramp down zero (0) data point is similar to the voltage ramp up zero (0) voltage data point). When no voltage was applied, the liquid crystal materials and the liquid crystal domains, located in the different liquid crystal layers of the device, orient perpendicular to the devices' opposing surfaces (homeotropic alignment), allowing light to pass through the device. Also when there was no voltage applied to the device, ammonium cations and halide anions (ions associated with the CTAB/HTAB in the alignment layer) are diffused throughout the different liquid crystal layers. When voltage is applied across the device, the ions begin to migrate creating ion passages or streams through the different liquid crystal layers. This movement of the ions destroys the uniaxial orientation of the liquid crystal material and liquid crystal domains resulting in a random orientation of the liquid crystal material and liquid crystal domain, which scatters incoming light resulting in high haze. When the device was switched, at about 40 volts' maximum haze was achieved, about 88%. As shown in FIG. 5, the reverse sample, the hysteresis of the device was negligible which indicates the relaxation of the liquid crystal material and the return to its original orientation. FIG. 6 shows a comparison of the % haze at increasing voltages with different wt % of the PDMS. FIG. 6 shows that there are similar on state and off state haze results when the PDMS content varied from 5 wt % to about 30 wt %.

### Experiment 3.2: Comparative Example of Measurement of Device Haze

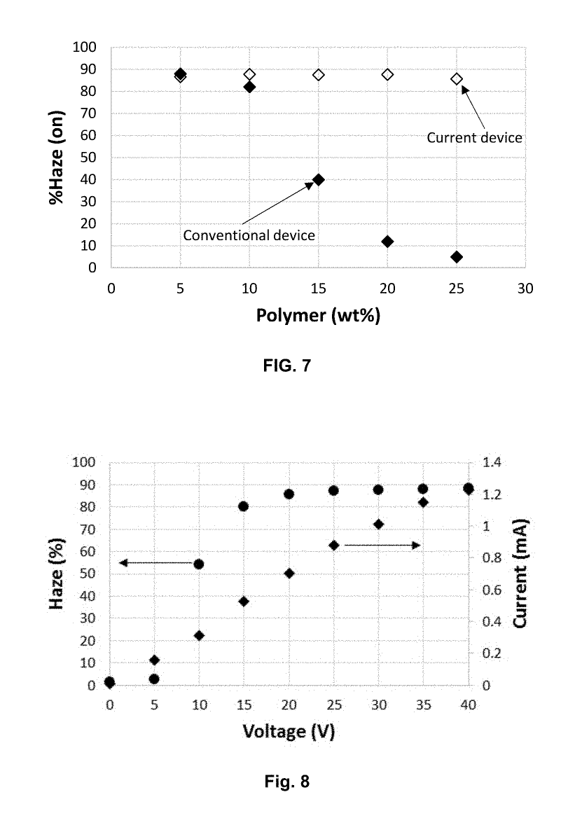

FIG. 7 shows the results of a comparative device study. A conventional reverse-mode polymer stabilized liquid crystal device was fabricated varying the LC-242 (BASF) monomer wt % concentration (5 to 25 wt %). Measurements and data acquisition was performed same as above in example 3.1. The on state haze measured at 20 V was recorded for the different monomer concentrations and compared with a device fabricated with PDMS polymer. As shown in FIG. 7 at 5 wt % both the monomer and the polymer produced good haze, >80% haze. However, as the wt % of the monomer increases the % haze decreases, this was in stark contrast to the PDMS polymer, where the % haze remains relatively constant as the wt % if the polymer increases. The high density of LC-242 monomer resists the re-orientation of the liquid crystals under applied voltage. On the other hand, the soft and diffusible PDMS polymer, did not exert any re-orientation resistance for the liquid crystal, resulting in the on-state haze remaining almost unchanged within the differing wt % increases.

### Example 4

### Measurement of Device Current

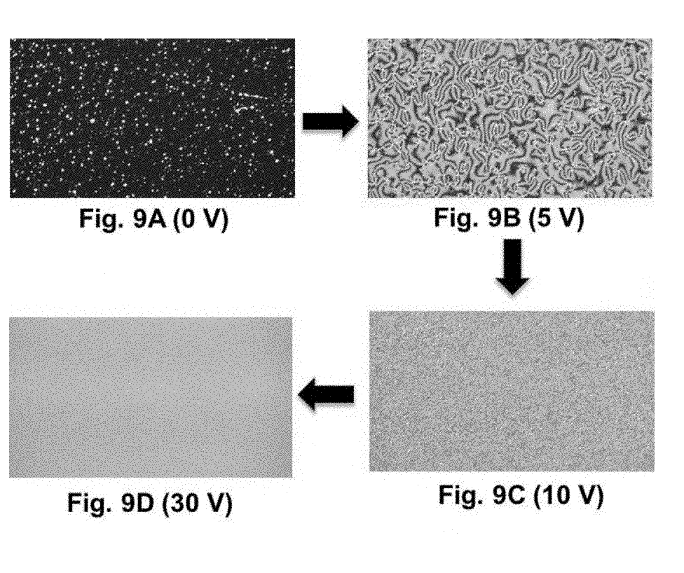

The operating principle of current high haze device is due to both the flow of ions within the device during the on-state and the decrease barrier of rotation due to the PDMS's silicon-oxygen backbone. Because the ionic flow is proportional to the current applied to the device the current-voltage relationship was explored. In the device, the current will be proportional to the movement of ionic species. In Example 4, the ionic conductivity was measured in terms of current flow across the device. For this experiment the device was connected to a voltage source (3PN117C Variable Transformer; Superior Electric, Farmington, CT, USA) via electrical wires, one wire connected to a terminal which corresponded to a respective ITO glass substrate on the device, such that when the voltage source was turned on an electrical field was applied across the device. A digital multimeter (Tektronix, DMM 4050 6-1/2 Digital Precision Multimeter, Beaverton, Oregon, USA) was connected in series with the device and the voltage source to measure the voltage and current. FIG. 8 shows the results of for the voltage vs. %haze (circles) and the current vs voltage (diamonds). As depicted in the graph, when the voltage increases, the current increases due to ionic movement within the device and as the voltage increases the corresponding %haze increases. The ionic movement can be visualized indirectly by the polarizing microscope images, FIGS. 9A-9D, upon applied voltage. As the voltage increased from 0 volts to about 30 volts, the device changes from the homeotropic aligned liquid crystals, depicted in FIG. 9A as a black image (the polymer) with white dots or specs (the homeotropic aligned liquid crystals), to homogeneous alignment, FIG. 9B, at 5 volts, the colored pattern created by ionic conductance and interactions with the ions and liquid crystals due to light retardation. When the voltage increases to 10 volts, we can see the optical interference pattern changes where many small domains flickering light with rapid liquid crystal re-orientation, also known as the start of the scattering state FIG. 9C. At around 30 volts, a strong light scattering state was achieved FIG. 9D.

### Example 5

### Liquid Crystal Composite Polarization Observations

The multilayered liquid crystal element was examined with an optical microscope in a crossed polarization lighting condition to characterize the liquid crystal behavior in different layers and to study the composition's birefringence, or the difference between high and low refractive index of anisotropic liquid crystal molecules and polymer matrix.

A polarizing microscope (BX-53F; Olympus, Tokyo, Japan) with the analyzer (U-PA, Olympus) rotated 90 degrees from the polarizer filter (BX45-PO, Olympus) and in the optical path of a 100-watt halogen light attachment (U-LH100HG, Olympus) and a video camera (U-TVO.35XC-2, Olympus). The samples were placed on the microscope's stage within the halogen lamp's optical path. If the sample was isotropic, the halogens light would be nearly completely blocked. However, if the sample was anisotropic, light will pass through the sample.

Additionally, a heating stage (FP 82 HT, Mettler Toledo, Columbus, Ohio, USA) and associated controller (FP 90, Mettler Toledo) can be used to heat the samples sandwiched in glass to preset temperatures right before measurements are taken. The purpose was to determine the birefringence properties of the samples at specific temperatures in order to determine their phase as a function of temperature.

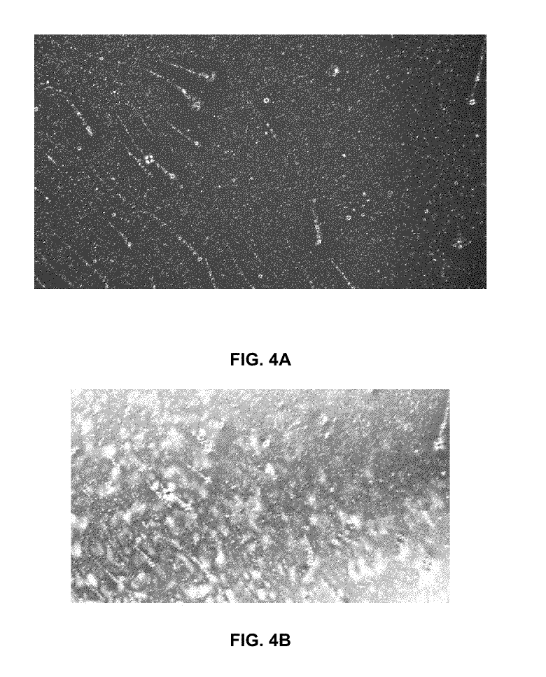

The aforedescribed element was placed in-between the polarizer and analyzer. The experiment was done without an applied voltage. FIG. 4A, is a picture that depicts the second liquid crystal composite layer of the element, containing the polymerized polymer with liquid crystal domains embedded within. The black area corresponds to the polymeric materials and the bright dots or spots in the image correspond to the liquid crystal domains embedded in the isotropic polymer matrix. Because of the birefringence of liquid crystals, we can see those bright spots.

FIG. 4b is a picture depicting the first and third liquid crystal composite layer of the element, which contains the phase separated fluid liquid crystal materials. In order to visualize the fluid phase, the device was mechanically pushed on the surface causing the fluid layer to be displaced and/or change their orientation with the alignment layer. This displacement and/or change in liquid crystal orientation with regard to the alignment layer was visualized by the brighter image and moving materials therein. In addition, polymerized polymer and liquid crystal domains of the second liquid crystal domains was also observed in the background/beneath the fluid liquid crystal phase. Similar images were also observed when the device were flipped to study opposite side of the element.

Unless otherwise indicated, all numbers expressing quantities of ingredients, properties such as molecular weight, reaction conditions, and so forth used in the specification and embodiments are to be understood as being modified in all instances by the term “about.” Accordingly, unless indicated to the contrary, the numerical parameters set forth in the specification and attached embodiments are approximations that may vary depending upon the desired properties sought to be obtained. At the very least, and not as an attempt to limit the application of the doctrine of equivalents to the scope of the embodiments, each numerical parameter should at least be construed in light of the number of reported significant digits and by applying ordinary rounding techniques.

The terms “a,” “an,” “the” and similar referents used in the context of describing the present disclosure (especially in the context of the following embodiments) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the present disclosure and does not pose a limitation on the scope of any embodiment. No language in the specification should be construed as indicating any non-embodied element essential to the practice of the present disclosure.

Groupings of alternative elements or embodiments disclosed herein are not to be construed as limitations. Each group member may be referred to and embodied individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended embodiments.

Certain embodiments are described herein, including the best mode known to the inventors for carrying out the present disclosure. Of course, variations on these described embodiments will become apparent to those of ordinary skill in the art upon reading the foregoing description. The inventor expects skilled artisans to employ such variations as appropriate, and the inventors intend for the present disclosure to be practiced otherwise than specifically described herein. Accordingly, the embodiments include all modifications and equivalents of the subject matter recited in the embodiments as permitted by applicable law. Moreover, any combination of the above-described elements in all possible variations thereof is contemplated unless otherwise indicated herein or otherwise clearly contradicted by context.

In closing, it is to be understood that the embodiments disclosed herein are illustrative of the principles of the disclosure. Other modifications that may be employed are within the scope of the embodiments. Thus, by way of example, but not of limitation, alternative embodiments may be utilized in accordance with the teachings herein. Accordingly, the embodiments are not limited to embodiments precisely as shown and described.

### Embodiments

The following embodiments are specifically contemplated by the authors of the present disclosure.
Embodiment 1 A liquid crystal composite comprising:

a first liquid crystal composite layer, comprising at least one liquid crystal compound and a polymer, the first liquid crystal composite layer having a first liquid crystal concentration and a first polymer concentration; and

a second liquid crystal composite layer, comprising at least one liquid crystal compound and a polymer, the second liquid crystal composite layer having a second liquid crystal concentration and a second polymer concentration.
Embodiment 2 The liquid crystal composite of embodiment 1, wherein the first liquid crystal composite layer comprises a substantially fluid phase.
Embodiment 3 The liquid crystal composite of embodiment 1 or 2, further comprising a third liquid crystal composite layer, comprising at least one liquid crystal compound and a polymer, the third liquid crystal concentration and third polymer concentration.
Embodiment 4 The liquid crystal composite of embodiment 3, wherein the third liquid crystal composite layer comprises a substantially fluid phase.
Embodiment 5 The liquid crystal composite of embodiment 1, 2, 3 or 4, wherein the second liquid crystal composite layer comprises a plurality of liquid crystal polymer domains disposed within a solid matrix.
Embodiment 6 The liquid crystal composite of embodiment 1, 2, 3, 4 and 5, further comprising an ionic compound.
Embodiment 7 The liquid crystal composite of embodiment 1, 2, 3, 4, 5 and 6, wherein the ionic compound is a quaternary ammonium salt.
Embodiment 8 The liquid crystal composite of embodiment 1, 2, 3, 4, 5, 6 and 7, wherein the quaternary ammonium salt is comprises of a quaternary ammonium cation.
Embodiment 9 The liquid crystal composite of embodiment 1, 2, 3, 4, 5, 6, 7 and 8, wherein the quaternary ammonium cation is a cetyltrimethyl-ammonium.
Embodiment 10 The liquid crystal composite of embodiment 1, 2, 3, 4, 5, 6, 7 and 8, wherein the quaternary ammonium cation is a hexadecyltrimethyl-ammonium.
Embodiment 11 The liquid crystal composite of embodiment 1, 2, 3, 4, 5, 6, 7, 8, 9 and 10, wherein the first liquid crystal composite layers' percentage by weight of the polymer material in the composite is between 5 wt %.
Embodiment 12 The liquid crystal composite of embodiment 1, 2, 3, 4, 5, 6, 7, 8, 9, 10 and 11, wherein the second liquid crystal composite layers' percentage by weight of the polymer material is about 50 wt %.
Embodiment 13 The liquid crystal composite of embodiment 1, 2, 3, 4, 5, 6, 7, 8, 9, 10, 11 and 12, wherein the first liquid crystal composite layers' percentage by weight of the liquid crystal material in the composite is about 95 wt %.
Embodiment 14 The liquid crystal composite of embodiment 1, 2, 3, 4, 5, 6, 7, 8, 9, 10, 11, 12 and 13, wherein the second liquid crystal composite layers' percentage by weight of the liquid crystal material in the composite is about 50 wt %.
Embodiment 15 The liquid crystal composite of embodiment 1, 2, 3, 4, 5, 6, 7, 8, 9, 10, 11, 12, 13 and 14, wherein the polymer material is a soft polymer.
Embodiment 16 The liquid crystal composite of embodiment 1, wherein the polymer material is polydimethylsiloxane.
Embodiment 17 The liquid crystal composite of embodiment 1, wherein the liquid crystal material is nematic.
Embodiment 18 The liquid crystal composite of embodiment 1, wherein the liquid crystal material has a negative anisotropy.
Embodiment 19 A method for making a reverse anisotropy window comprising:

filling a cell with the liquid crystal composite of embodiment 1, 2, 3, 4, 5, 6, 7, 8, 9, 10, 11, 12, 13, 14 and 15;

heating the filled cell above the nematic-isotropic transition temperature for the liquid crystal material; and

cooling the filled cell below the isotropic-nematic transition temperature to change the liquid crystal material into the nematic phase and create an annular gap between the cured solid phase polymer and fluid phase liquid crystal material.
Embodiment 20 A liquid crystal element, the element comprising:

a transparency changing layer, the layer comprising the liquid crystal composite of embodiments 1, 2, 3, 4, 5, 6, 7, 8, 9, 10, 11, 12 or 13 having a first opposing surface and a second opposing surface; and

a first alignment layer bounding the first opposing surface; and

a second alignment layer bounding the second opposing surface.
Embodiment 21 The liquid crystal element of embodiment 15, wherein the liquid crystal composite occupies a gap defined by the first alignment layer bounding the first opposing surface and the second alignment layer bounding the second opposing surface.
Embodiment 22 A selectively dimmable device comprising:

at least two conductive substrates, a first conductive substrate and a second conductive substrate defining a gap there between;

the liquid crystal element of embodiment 15, disposed in the gap between the first conductive substrate and second conductive substrate; and

a voltage source, where the first conductive substrate, the second conductive substrate, the liquid crystal element, and the voltage source are all in electrical communication such that when a voltage is provided by the voltage source, an electric field is applied across the element.
Embodiment 23 The device of embodiment 22, the device having a haze of at most 5% when there is no voltage applied and a haze of at least 80% when a voltage of 25 volts or more is applied across the device.

What is claimed is:

1. A liquid crystal composition comprising:
a reverse-mode heterogeneously mixed polymer dispersed liquid crystal (PDLC) composition, wherein the PDLC comprises a liquid crystal material and a polymer;
a first liquid crystal composite layer having a first concentration of the liquid crystal material and a first concentration of the polymer; and
a second liquid crystal composite layer, having a second concentration of the liquid crystal material and a second concentration of the polymer, and disposed between the first liquid crystal composite layer and a third liquid crystal composite layer;
wherein the third liquid crystal composite layer has a third concentration of the liquid crystal material and third concentration of the polymer.

2. The liquid crystal composite of claim 1, wherein the first and third liquid crystal composite layers comprise a substantially fluid phase.

3. The liquid crystal composite of claim 1, wherein the second liquid crystal composite layer comprises a plurality of liquid crystal polymer domains disposed within a solid matrix.

4. The liquid crystal composite of claim 1, wherein the polymer comprises a soft polymer material.

5. The liquid crystal composite of claim 1, wherein the polymer comprises a polydimethylsiloxane material.

6. The liquid crystal composite of claim 1, further comprising an ionic compound.

7. The liquid crystal composite of claim 6, wherein the ionic compound is a quaternary ammonium salt.

8. The liquid crystal composite of claim 7, wherein the quaternary ammonium cation is cetyltrimethyl-ammonium.

10. The liquid crystal composite of claim 1, wherein the liquid crystal material is nematic.

11. The liquid crystal composite of claim 1, wherein the liquid crystal material is a negative anisotropic material.

12. A liquid crystal element comprising:
a layer comprising the liquid crystal composite of claim 1, and having a first surface and a second surface; and
a first alignment layer bounding the first surface and a second alignment layer bounding the second surface.

13. A selectively dimmable device comprising:
the liquid crystal element of claim 12 disposed between a first conductive substrate and a second conductive substrate; and
a voltage source, wherein
the liquid crystal element, the first conductive substrate, the second conductive substrate and the voltage source are all in electrical communication with each other such that when a voltage is provided by the voltage source an electric field is applied across the liquid crystal element.

14. The device of claim 13, wherein the device has a haze of at most 5% when there is no voltage applied across the device.

15. The device of claim 13, wherein the device has a haze of at most 3% when there is no voltage applied across the device.

16. The device of claim 13, wherein the device has a haze of at least 80% when a voltage of 25 volts is applied across the device.

17. The device of claim 13, wherein the device has a haze of at least 85% when a voltage of 20 volts is applied across the device.

18. The device of claim 13, wherein the substrates are flexible so that the device forms a flexible sheet.

19. The device of claim 13, further comprising a sealant to protect the liquid crystal element from the environment.

20. The device of claim 13, further comprising an adhesive layer with a removable backing.
